(19) United States
(12) Patent Application Publication
(10) Pub. No.: US 2004/0084476 A1
(43) Pub. Date: May 6, 2004

(54) Dispensing apparatus for a pack for drink

(76) Inventors: Chien-Fu Lin, Taichung (TW); Chi-Yang Liao, Taichung (TW); Gino Lu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/287,649

(22) Filed: Nov. 5, 2002

(51) Int. Cl. B67D 5/00

(52) U.S. Cl. 222/83

(57) ABSTRACT

A dispensing apparatus includes a dispenser for insertion in a pack for drink and a cap for concealing the dispenser. The dispenser defines a space extending for an entire length thereof and includes a mouthpiece formed on an end, an insert formed on an opposite end and a stop formed between the mouthpiece and the insert. The cap can be mounted on the mouthpiece or the insert. The insert includes a cutting edge. The cutting edge includes a point. The cap includes a plug for insertion in the dispenser. The dispenser includes a ridge formed on an internal face, and the plug includes a ridge formed thereon for engagement with the ridge of the dispenser when the plug is inserted in the dispenser. The insert defines an aperture communicated with the space of the dispenser and located adjacent to the stop.

### BACKGROUND OF INVENTION

1. Field of Invention

The present invention relates packs for drinks and, more particularly, to a dispensing apparatus for a pack for drink.

2. Related Prior Art

Drinks are sold in various ways, e.g., in cans, bottles and packs. Most of the packs include a structure made of a board of paper and a bag made of a foil of aluminum. The foil of aluminum is bonded with the board of paper, thus forming a laminate. Then, the laminate is shaped as a pack.

In a design, no weak point is provided in the pack. In use, a corner has to be cut from the pack by means of a pair of scissors or a knife so as to define an orifice through which drink can be poured. A pair of scissors or a knife is necessary for getting drink from the pack.

In another design, an orifice is defined in the structure during production of the pack. A straw with a point, i.e., sharp tip, is inserted through the orifice defined in the structure in order to pierce the bag. Thus, the straw is inserted in the bag. Drink can be sucked from the pack through the straw. However, this design is not suitable for two persons wanting to share a pack of drink.

Taiwanese Patent Publication No. 333197 discloses a pack for drink. The pack includes a structure made of a rectangular board of paper and a bag made of a rectangular foil of aluminum. In production of the pack, two corners are cut from the rectangular board of paper. The foil of aluminum is bonded with the board of paper. Two corners of the foil of aluminum extend beyond the chamfered corners of the board of paper. When the structure and the bag are made, a corner 12 of the bag is exposed through an orifice 11 defined in the structure. A person is supposed to remove the corner 12 from the bag without using any tool. Therefore, a balance between the capability of sealing the drink and the easiness of removing the corner 12 without use of a tool is important. However, such a balance often requires a high level of manufacturing and a high cost.

The present invention is therefore intended to obviate or at least alleviate the problems encountered in prior art.

### SUMMARY OF INVENTION

It is an objective of the present invention to provide a convenient dispensing apparatus for a pack for drink.

It is another objective of the present invention to provide an inexpensive dispensing apparatus for a pack for drink.

According to the present invention, a dispensing apparatus includes a dispenser for insertion in a pack for drink and a cap for concealing the dispenser. The dispenser defines a space extending for an entire length thereof and includes a mouthpiece formed on an end, an insert formed on an opposite end and a stop formed between the mouthpiece and the insert. The cap can be mounted on the mouthpiece or the insert. The insert includes a cutting edge. The cutting edge includes a point. The cap includes a plug for insertion in the dispenser. The dispenser includes a ridge formed on an internal face, and the plug includes a ridge formed thereon for engagement with the ridge of the dispenser when the plug is inserted in the dispenser. The insert defines an aperture communicated with the space of the dispenser and located adjacent to the stop.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a dispensing apparatus for a pack for drink according to a first preferred embodiment of the present invention.

FIG. 2 is an exploded view of the dispensing apparatus according to the first embodiment of the present invention, showing that the dispensing apparatus including a dispenser and a cap.

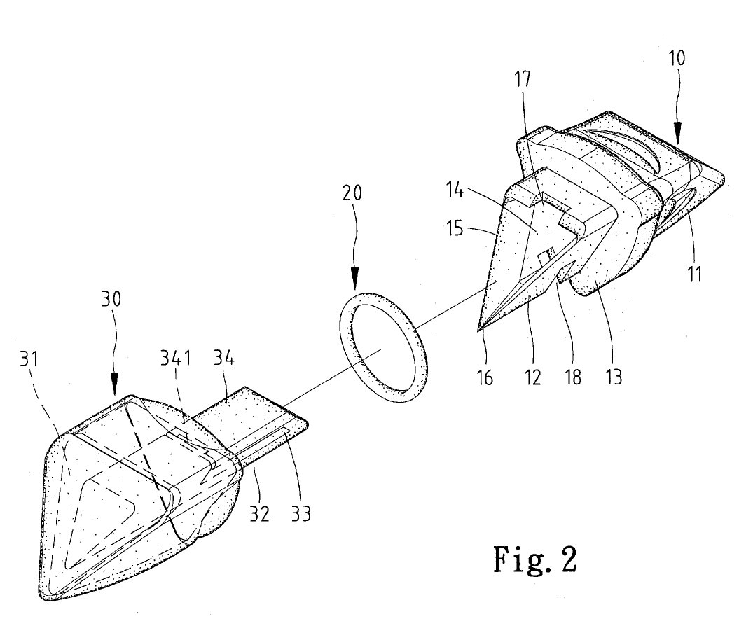

FIG. 3 is a cross-sectional view of the dispensing apparatus according to the first embodiment of the present invention.

FIG. 4 is a cross-sectional view of a pack on which the dispenser according to the first embodiment of the present invention is mounted, showing the pack in a position for pouring drink.

FIG. 5 is a cross-sectional view of the pack on which the dispenser according to the first embodiment of the present invention is mounted, showing the pack in another position for pouring drink.

FIG. 6 is a cross-sectional view of the pack on which the dispensing apparatus according to the first embodiment of the present invention is mounted, showing the dispenser sealed by means of the cap.

FIG. 7 is an exploded view of a dispensing apparatus according to a second embodiment of the present invention, showing that the dispensing apparatus including a dispenser and a cap.

FIG. 8 is a cross-sectional view of the dispensing apparatus according to the second embodiment of the present invention, showing the dispenser engaged with the cap in a first position.

FIG. 9 is a cross-sectional view of the dispensing apparatus according to the second embodiment of the present invention, showing the dispenser engaged with the cap in a second position.

### DETAILED DESCRIPTION OF EMBODIMENTS

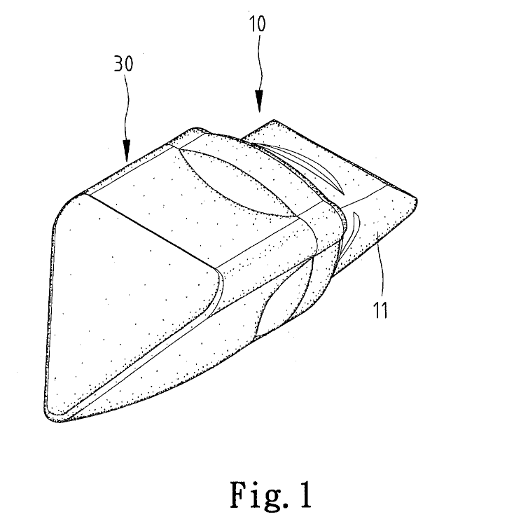

Referring to FIGS. 1˜3, according to a first embodiment of the present invention, a dispensing apparatus includes a dispenser 10, a ring 20 and a cap 30.

The dispenser 10 includes a mouthpiece 11 formed on an end, an insert 12 formed on an opposite end and a stop 13 formed between the mouthpiece 11 and the insert 12. The dispenser 10 defines a space 14 extending for an entire length thereof, i.e., through the dispensing 11, the insert 12 and the stop 13. Thus, the dispenser 10 includes an internal face and an external face. A ridge 141 is formed on the internal face of the dispenser 10. The mouthpiece 11 includes a triangular profile when viewed in an axial direction. So does the insert 12. The insert 12 includes a cutting edge 15 that includes a point 16. A cutout 17 is defined in the cutting edge 15. The insert 12 defines an aperture 18 near the stop 30. The space 14, the cutout 17 and the aperture 18 are in communication with one another.

The cap 30 includes a space 31 for selective receipt of the mouthpiece 11 or the insert 12. Thus, the cap 30 includes a top, a periphery, a plug 32 extending from the top and a hook 34 extending from the plug 32 toward the top. A gap 33 is defined between the plug 32 and the hook 34. The hook 34 is formed with a ridge 341.

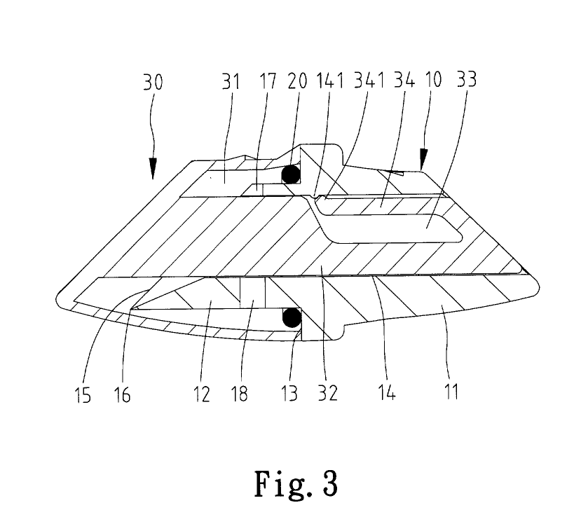

Referring to FIG. 3, when not in use, the cutting edge 15 formed with the point 16 is concealed by means of the cap 30 so as to avoid damage of people thereby. In this position, the ring 20 is mounted on the insert 12, and the insert 12 is entirely inserted in the space 31 defined in the cap 30. The piston 32 is inserted in the space 14 defined in the dispenser 10. The ridge 341 of the cap 30 is engaged with the ridge 141 of the dispenser 10 so as to retain the cutting edge 15 concealed by means of the cap 30.

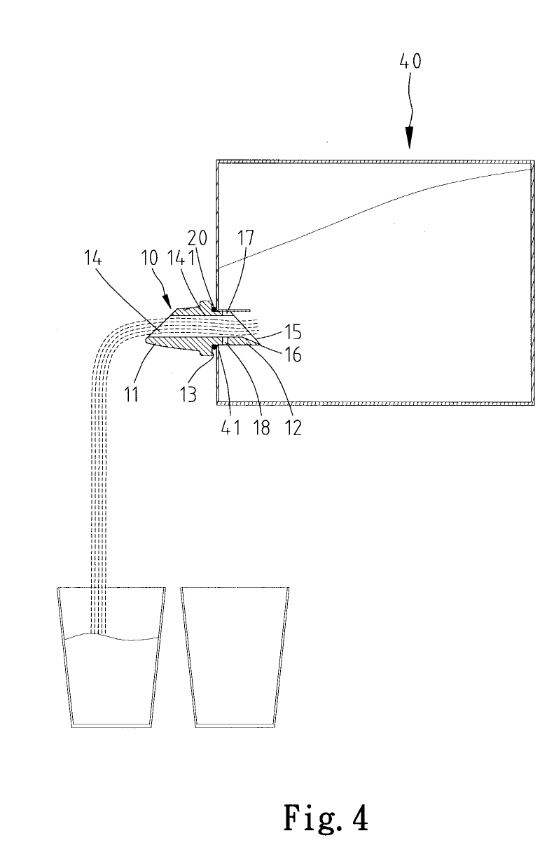

Referring to FIG. 4, in use, the cap 30 is removed from the insert 12. The insert 12 is forced into a pack 40 for drink. During the process of insertion, the point 16 pierces an aperture 41 in the pack 40, and the cutting edge 15 enlarges the aperture 41 via cutting. Thus, drink can be poured from the pack 40 into a cup through the dispenser 30. The stop 13 prevents complete insertion of the dispenser 10 into the pack 40. The ring 20 prevents undesirable leakage of the drink.

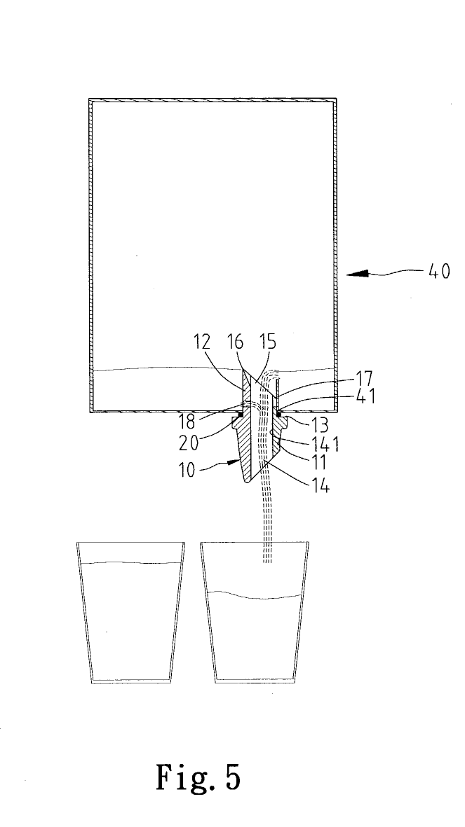

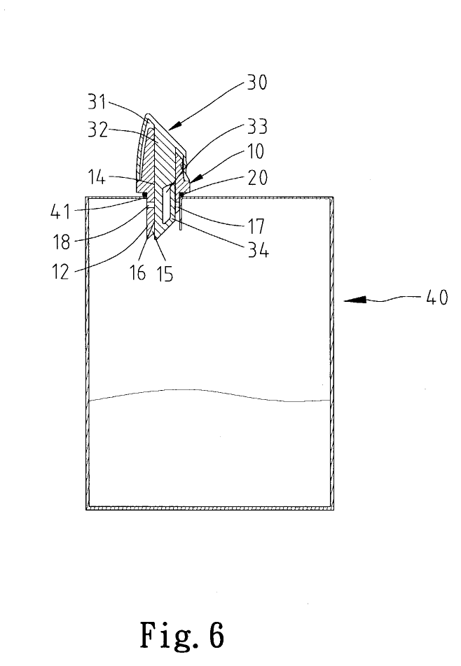

Referring to FIG. 5, to completely pour the drink from the pack 40, the pack 40 is positioned upside down. The cutout 17 and the aperture 18 help to this end. Referring to FIG. 6, if complete pouring of the drink from the pack 40 is not desired, the cap 30 is mounted on the mouthpiece 11. The plug 32 is inserted in the space 14 defined in the dispenser 10 in order to prevent leakage of the drink from the pack 40 and avoid entering of miscellaneous articles into the pack 40.

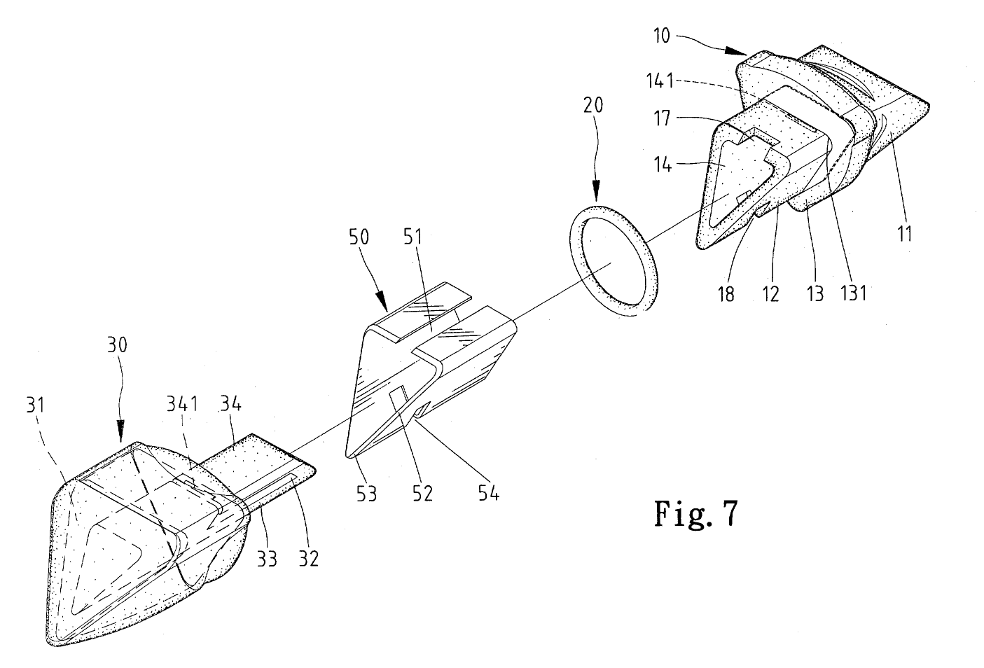

FIGS. 7˜9 show a dispensing apparatus according to a second embodiment of the present invention. The second embodiment is different from the first embodiment in that the insert 12 does not include the cutting edge 15 and the point 16, that it includes a piercing element 50 and that the stop 13 defines a groove 131 for receiving the piercing element 50. The piercing element 50 includes a cutting edge 52 formed with a point 53. The piercing element 50 defines a slot 51 corresponding to the cutout 17 defined in the insert 12 and an aperture 54 corresponding to the aperture 18 defined in the insert 12. The piercing element 50 is mounted on the insert 12 so that the slot 51 is communicated with the cutout 17 and that the aperture 54 is aligned with the aperture 18. The functions of the cutting edge 52 and the point 53 are identical to that of the cutting edge 15 and the point 16, respectively, and therefore will not be discussed in detail.

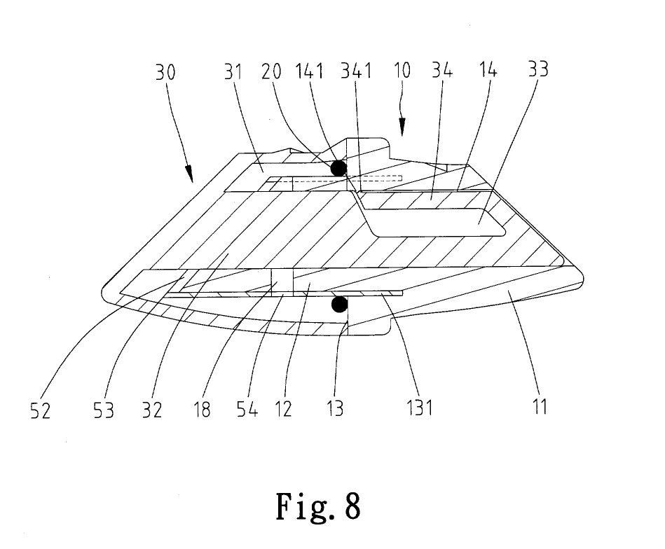

Referring to FIG. 8, the cap 30 is mounted on the piercing element 50 that is mounted on the insert 12 when not in use. Thus, the cutting edge 52 formed with the point 53 is concealed by means of the cap 30 so as to avoid damage of people thereby. In this position, the ring 20 is mounted on the insert 12, and the piercing element 50 is entirely inserted in the space 31 defined in the cap 30. The piston 32 is inserted in the space 14 defined in the dispenser 10. The ridge 341 of the cap 30 is engaged with the ridge 141 of the dispenser 10 so as to retain the cutting edge 52 concealed by means of the cap 30.

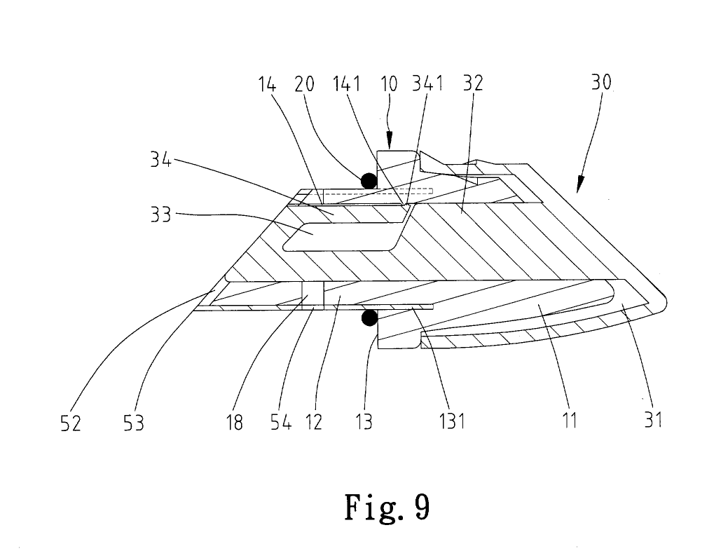

Referring to FIG. 9, in use, the cap 30 is removed from the piercing element 50. The piercing element 50 and the insert 12 can be forced into a pack for drink. In the process of insertion, the point 53 can pierce an aperture in the pack, and the cutting edge 52 enlarges the aperture via cutting. Thus, drink can be poured from the pack into a cup through the dispenser 30.

The present invention has been described via detailed illustration of the embodiments. Those skilled in the art can derive many variations from the embodiments without departing from the scope of the present invention. Therefore, the embodiments shall not limit the scope of the present invention as defined in the attached claims.

1. A dispenser defining a space extending for an entire length thereof and including a mouthpiece formed on an end, an insert formed on an opposite end for insertion in a pack for drink and a stop formed between the mouthpiece and the insert for avoiding the mouthpiece entering the pack.

2. The dispenser according to claim 1 wherein the insert includes a cutting edge for piercing the pack.

3. The dispenser according to claim 2 wherein the cutting edge includes a point formed thereon.

4. A dispensing apparatus including a dispenser for insertion in a pack for drink and a cap for concealing the dispenser.

5. The dispensing apparatus according to claim 4 wherein the dispenser defines a space extending for an entire length thereof and includes a mouthpiece formed on an end, an insert formed on an opposite end and a stop formed between the mouthpiece and the insert, and the cap can be selectively mounted on one of the mouthpiece and the insert.

6. The dispenser according to claim 5 wherein the insert includes a cutting edge for piercing the pack.

7. The dispenser according to claim 6 wherein the cutting edge includes a point formed thereon.

8. The dispensing apparatus according to claim 5 wherein the cap includes a plug for insertion in the dispenser.

9. The dispensing apparatus according to claim 8 wherein the dispenser includes a ridge formed on an internal face, and the plug includes a ridge formed thereon for engagement with the ridge of the dispenser when the plug is inserted in the dispenser.

10. The dispensing apparatus according to claim 9 wherein the plug includes a hook extending from the plug toward the cap, and the ridge of the plug is formed on the hook.

11. The dispenser according to claim 5 wherein the insert defines an aperture communicated with the space of the dispenser and located adjacent to the stop.

12. A dispensing apparatus including a dispenser, a piercing element mounted on the dispenser for piercing a pack for drink and a cap for selectively concealing one of the dispenser and the piercing element.

13. The dispensing apparatus according to claim 12 wherein the dispenser defines a space extending for an entire length thereof and includes a mouthpiece formed on an end, an insert formed on an opposite end and a stop formed between the mouthpiece and the insert for avoid the mouthpiece entering the pack, and the piercing element is mounted on the insert.

14. The dispensing apparatus according to claim 13 wherein the stop defines a groove for receiving the piercing element.

15. The dispensing apparatus according to claim 12 wherein the piercing element includes a cutting edge.

16. The dispenser according to claim 15 wherein the cutting edge includes a point.

17. The dispensing apparatus according to claim 12 wherein the cap includes a plug for insertion in the dispenser.

18. The dispensing apparatus according to claim 17 wherein the dispenser includes a ridge formed on an internal face, and the plug includes a ridge formed thereon for engagement with the ridge of the dispenser when the plug is inserted in the dispenser.

19. The dispensing apparatus according to claim 18 wherein the plug includes a hook extending from the plug toward the cap, and the ridge of the plug is formed on the hook.

20. The dispenser according to claim 13 wherein the insert defines an aperture communicated with the space of the dispenser and located adjacent to the stop, and the piercing element defines an aperture corresponding to the aperture defined in the insert.
